(19) United States
(12) Patent Application Publication
(10) Pub. No.: US 2003/0063238 A1
(43) Pub. Date: Apr. 3, 2003

(54) Method of fabricating color filter panel for liquid crystal display device using thermal imaging

(75) Inventors: Jong-Hoon Yi, Seoul (KR); Jeong-Hyun Kim, Kyonggi-do (KR); Jung-Jae Lee, Kyonggi-do (KR); Jae-Hong Jun, Seoul (KR)

Correspondence Address: MORGAN LEWIS & BOCKIUS LLP, 1111 PENNSYLVANIA AVENUE NW, WASHINGTON, DC, 20004, US

(73) Assignee: LG. Philips LCD Co., Ltd.

(21) Appl. No.: 10/134,616

(22) Filed: Apr. 30, 2002

(30) Foreign Application Priority Data
Sep. 28, 2001 (KR) P2001-060617

(51) Int. Cl. G02F 1/1335

(52) U.S. Cl. 349/106

(57) ABSTRACT

A method of fabricating a color filter panel for a liquid crystal display device includes aligning a transcription film having a color layer, a light-to-heat conversion layer, and a supporting film on a color filter substrate, selectively performing a thermal imaging process on the transcription film, and removing the transcription film except for a portion where the thermal imaging process is performed, thereby forming a color filter on the color filter substrate.

This application claims the benefit of the Korean Patent Application No. P2001-060617 filed on Sep. 28, 2001, which is hereby incorporated by reference.

### BACKGROUND OF THE INVENTION

1. Field of the Invention

The present invention relates to a liquid crystal display device, and more particularly, to a method of fabricating a color filter panel for a liquid crystal display device using thermal imaging.

2. Discussion of the Related Art

A liquid crystal display (LCD) device should include color filters in order to display color pictures. The color filters may include three sub-color filters of red (R), green (G), and blue (B).

The color filter is formed by a method such as a dyeing method, an electro-deposition method, a pigment dispersion method, and a printing method. Among these methods, the pigment dispersion method is generally used because a fine pattern is easily formed by such a method.

The conventional LCD device having a color filter will be described hereinafter in detail with reference to FIG. 1.

FIG. 1 is a cross-sectional view of a conventional LCD device. In FIG. 1, the conventional LCD device has a color filter panel 10 and an array panel 30 facing into each other, and a liquid crystal 50 disposed between the color filter panel 10 and the array panel 30.

More particularly, as shown in FIG. 1, the array panel 30 includes a first substrate 31, and a thin film transistor “T” is formed on the first substrate 31. A pixel electrode 32 of a transparent conducting material is also formed at the pixel area “P” on the first substrate 31. The pixel electrode 32 is connected to the thin film transistor “T”, which transmits signals to the pixel electrode 32 as a switching device. A first alignment layer 34 covers the thin film transistor “T” and the pixel electrode 32.

In the mean time, the color filter panel 10 includes a second substrate 11, and a black matrix 12 is formed on the inner surface of the second substrate 11. A color filter 14 is formed on the black matrix 12, and the color filter 14 is disposed in the pixel area “P”, overlapping the black matrix 12. As stated above, the color filter 14 has three sub-color filters of R, G, and B. Thereafter, an overcoat layer 16 is formed on the color filter 14. A common electrode 18 of a transparent conducting material is then formed on the overcoat layer 16 and a second alignment layer 20 is formed on the common electrode 18.

As stated above, the liquid crystal 50 is disposed between the color filter panel 10 and the array panel 30, namely, between the first alignment layer 34 and the second alignment layer 20. The early alignment of the liquid crystal 50 depends on the characteristics of the alignment layers 34 and 20.

Here, the thin film transistor “T” includes a gate electrode (not shown) connected to a scanning line (not shown), an active layer (not shown) formed on the gate electrode, and source and drain electrodes (not shown) separated apart from each other on the active layer. The active layer exposed between the source and drain electrodes is a channel. A photo leakage current is induced when the light is irradiated on the channel. Therefore, the black matrix 12 prevents the light from getting into the channel so that the photo leakage current is not generated. Also, the black matrix 12 corresponds to the area except for the pixel area “P”, so that the black matrix 12 covers the leakage light from the edge of the pixel electrode 32. An aperture ratio of the LCD device varies with a width of the black matrix 12. Therefore, the width of the black matrix 12 is designed to be narrow enough not to affect the aperture ratio.

FIGS. 2A to 2C are illustrating the steps of fabricating the color filter panel for the conventional LCD device of FIG. 1.

As shown in FIG. 2A, a black matrix 12 is formed on a transparent substrate 11. The black matrix 12 is formed of an inorganic material such as chromium (Cr), Cr/CrOx, or an organic material including carbon (C). Here, the material including chromium is formed by a sputtering method under a vacuum condition. Therefore, a process of manufacturing is complicated and a manufacturing expense becomes high. On the other hand, the organic material has several advantages such as short process, low cost, and high visibility. Therefore, the organic material becomes the choice of material for the black matrix.

In FIG. 2B, a color filter 14 is formed at the pixel area “P” on the transparent substrate 11 having the black matrix 12. The color filter 14 overlaps the black matrix 12. The color filter 14 includes three sub-color filters 14a, 14b, and 14c of R, G. and B, and each sub-color filter corresponds to each pixel area “P”. As stated above, the color filter 14 may be formed by a pigment dispersion method, which includes steps of coating a color resin on a substrate, exposing the color resin to a light, and developing the color resin. The color resin is photosensitive. Here, the color filter 14 has a step coverage “L” due to the step coverage of the black matrix 12.

FIG. 2C shows a step of fabricating an overcoat layer in the conventional color filter panel. An overcoat layer 16 is formed on the color filters 14 protecting the color filter 14 from the moisture and the air. It also planarizes the surface of the transparent substrate 11 including the color filter 14 and the black matrix 12. The overcoat layer 16 is formed of acrylic resin.

In FIG. 2D, a common electrode 18 and an alignment layer 20 are subsequently formed on the overcoat layer 18. The common electrode 18 is formed of a transparent conducting material, while the alignment layer 20 is formed of polyimide.

FIG. 3 illustrates the magnified region “A” of FIG. 2D. As shown in FIG. 3, the color filter 14 covers a part of the black matrix 12 in order to prevent a misalignment. As mentioned above, the width “d” of the black matrix 12 is made as narrow as possible for a better aperture ratio. However, it is difficult to control the width “d” of the black matrix 12 because the overlapped width of the color filter 14 varies with a manufacturing process and a material. For example, the black matrix 12 has a width of 24 μm in the 14-inch extended graphics array (XGA) type LCD device having a resolution of 1024 times 768 dots. The black matrix 12 should have a width less than 10 μm for a high aperture structure having the same resolution. If the width of the black matrix 12 is too narrow, a picture quality is deteriorated due to the light leakage.

In addition, the conventional LCD device requires a process of fabricating additional overcoat layer to planarize the surface of the color filter panel having a color filter.

### SUMMARY OF THE INVENTION

Accordingly, the present invention is directed to a method of fabricating a color filter panel for a liquid crystal display device that substantially obviates one or more of problems due to limitations and disadvantages of the related art.

Another object of the present invention is to provide a method of fabricating a color filter panel for a liquid crystal display device that has a planarized surface.

Another object of the present invention is to provide a method of fabricating a color filter for a liquid crystal display device, which reduces the steps of process and manufacturing expenses.

Additional features and advantages of the invention will be set forth in the description which follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method of fabricating a color filter panel for a liquid crystal display device includes aligning a transcription film having a color layer, a light-to-heat conversion layer, and a supporting film on a color filter substrate, selectively performing a thermal imaging process on the transcription film, and removing the transcription film except for a portion where the thermal imaging process is performed, thereby forming a color filter on the color filter substrate.

In another aspect of the present invention, a method of fabricating a color filter panel for a liquid crystal display device includes aligning a transcription film having a color layer, a light-to-heat conversion layer, and a supporting film on a color filter substrate, selectively performing a thermal imaging process on the transcription film, removing the transcription film except for a portion where the thermal imaging process is performed, thereby forming a color filter on the color filter substrate, and forming a black matrix between the color filters, the black matrix having a height substantially the same as the color filter.

In a further aspect of the present invention, a method of fabricating a liquid crystal display device includes aligning a transcription film having a color layer, a light-to-heat conversion layer, and a supporting film on a color filter substrate, selectively performing a thermal imaging process on the transcription film, removing the transcription film except for a portion where the thermal imaging process is performed, thereby forming a color filter on the color filter substrate, forming a black matrix between the color filters, the black matrix having a height substantially the same as the color filter, forming a thin film transistor on an array substrate, forming a pixel electrode on the array substrate, the pixel electrode being connected to the thin film transistor, and forming a liquid crystal layer between the array substrate and the color filter substrate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1 is a cross-sectional view of a conventional liquid crystal display device;

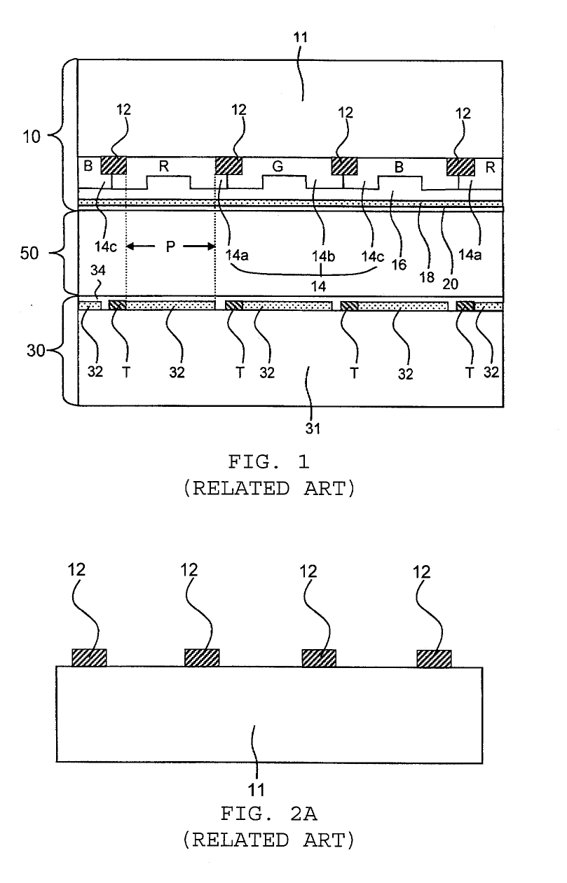

FIGS. 2A to 2D are cross-sectional views illustrating a method of fabricating a color filter panel for the conventional liquid crystal display device of FIG. 1;

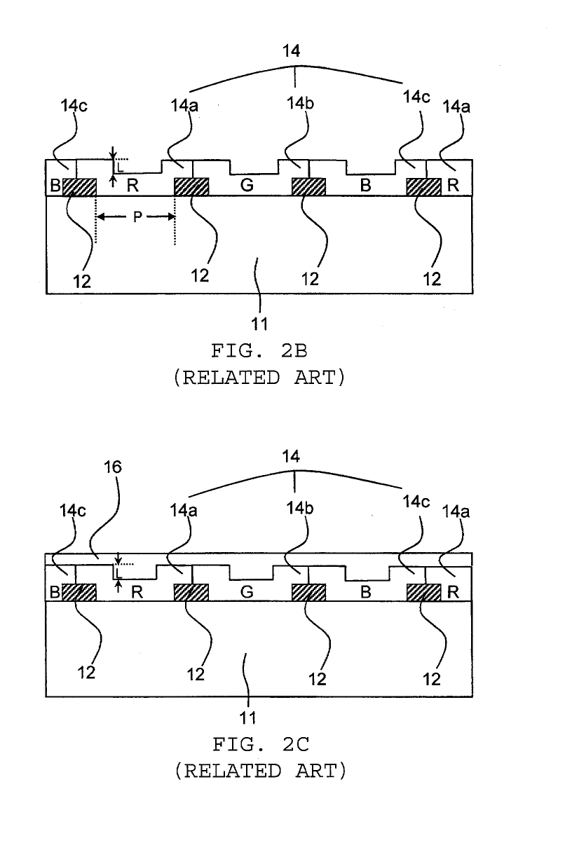

FIG. 3 is a magnified view of the region “A” of FIG. 2D;

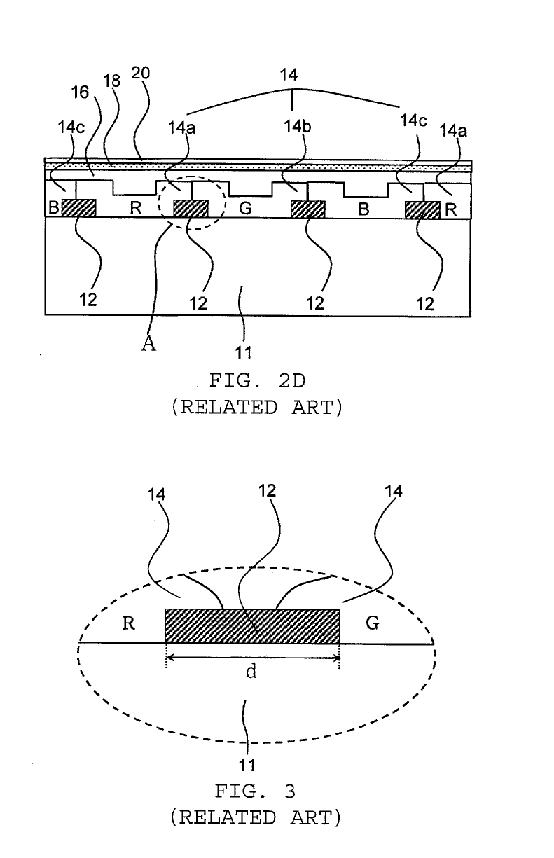

FIG. 4 is a cross-sectional view of a liquid crystal display according to the present invention;

FIG. 5 is a flow chart illustrating a process of fabricating a color filter panel according to the present invention;

FIGS. 6A to 6D are cross-sectional views illustrating a method of fabricating a color filter panel according to the present invention; and

FIG. 7 is a magnified view of the region “C” of FIG. 6D.

### DETAILED DESCRIPTION OF THE ILLUSTRATED EMBODIMENTS

Reference will now be made in detail to the illustrated embodiments of the present invention, examples of which are illustrated in the accompanying drawings. Wherever possible, the same reference numbers will be used throughout the drawings to refer to the same or like parts.

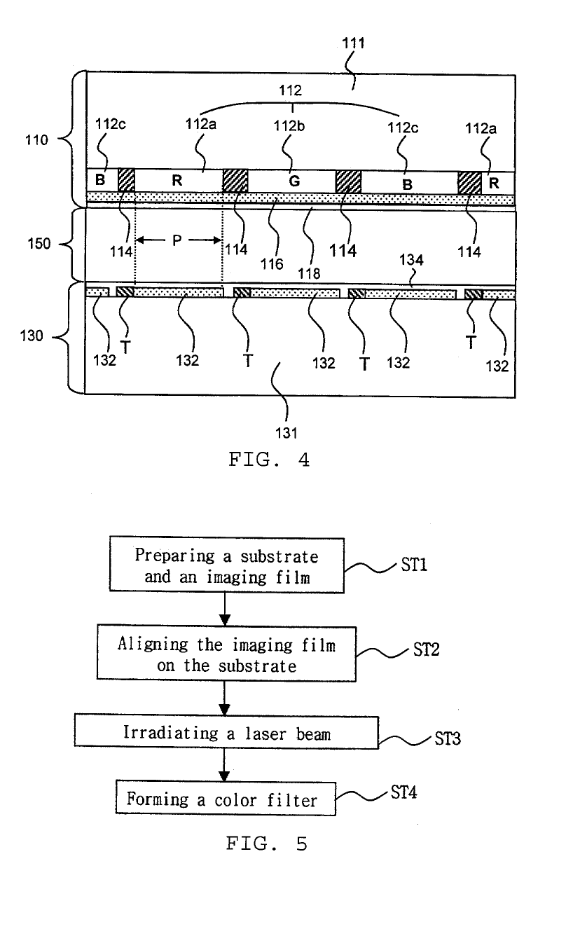

FIG. 4 is a cross-sectional view of a liquid crystal display (LCD) device according to the present invention. In FIG. 4, the LCD device includes a color filter panel 110, an array panel 130, and a liquid crystal 150 disposed between the color filter panel 110 and the array panel 130. The array panel 130 has a first substrate 131 formed of a transparent material such as glass. A thin film transistor “T” as a switching device is formed on the first substrate 131. The thin film transistor “T” includes a gate electrode, an active layer, a source electrode, and a drain electrode.

Continuously, a pixel electrode 132 is formed at the pixel area “P” on the first substrate 131, and connected to the thin film transistor “T”. Therefore, the pixel electrode 132 receives signals from the thin film transistor “T”. A first alignment layer 134 is formed on the first substrate 131 and covers the thin film transistor “T” and the pixel electrode 132.

Meanwhile, the color filter panel 110 facing into the array panel 130 has a second substrate 111 formed of a transparent material such as glass, and a color filter 112 is formed on the inner surface of the second substrate 111. The color filter 112 includes three sub-color filters 112a, 112b, and 112c of red (R), blue (B), and green (G) having a constant distance between the sub-color filters 112a, 112b, and 112c. Each sub-color filter corresponds to each pixel area “P”.

A black matrix 114 is formed on the inner surface of the second substrate 111. Here, the black matrix 114 is disposed in the space between the sub-color filters 112a, 112b, and 112c, and has the same height as the color filter 112. Therefore, an overcoat layer planarizing the surface of the second substrate 111 is not necessary. Next, a common electrode 116 is formed on the color filter 112 including the black matrix 114. The common electrode 116 may be formed of a transparent conducting material such as indium tin oxide (ITO). Also, a second alignment layer 118 is formed on the common electrode 116.

The first and second alignment layers 134 and 118 determine an early arrangement of the liquid crystal 150.

In the LCD device according to the present invention, the color filter is formed by a thermal imaging method. Thermal imaging is a method of irradiating a laser beam on the imaging film and transferring a pattern to the substrate. In the thermal imaging method, because coating and developing are not necessary, the number of the fabrication process is less than that of the other method such as a pigment dispersed method.

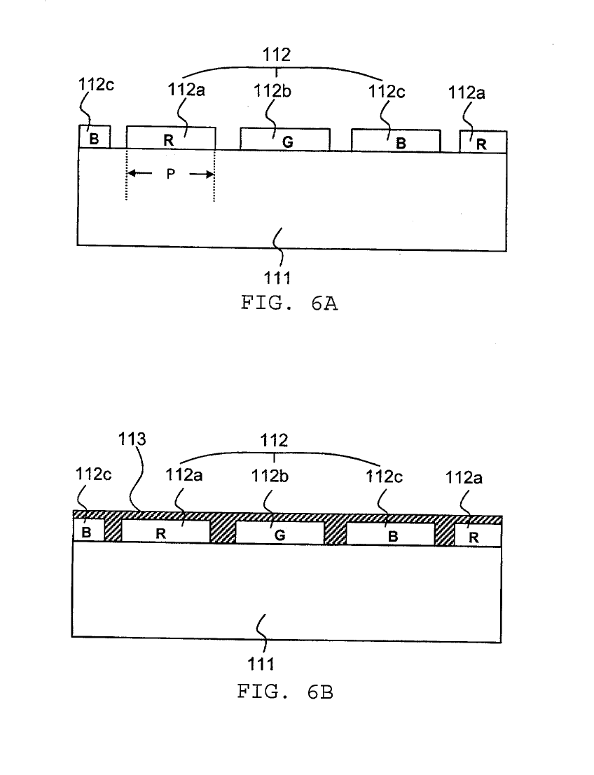

FIG. 5 is a flow chart illustrating a process of fabricating a color filter panel according to the present invention using a thermal imaging method.

In the first step, a transparent substrate and an imaging film are prepared (ST1). Here, the imaging film includes a color layer, a light-to-heat conversion (LTHC) layer, and a supporting substrate. The LTHC layer is made of a heat emitting material by the energy from a laser beam, and is disposed between the color layer and the supporting film.

In the next step, the imaging film is aligned on the transparent substrate (ST2). At this time, the color layer of the imaging film contacts the transparent substrate. In addition, an adhesive layer may be formed between the color layer and the transparent substrate. The adhesive layer may be formed on the transparent substrate or on the color layer of the imaging film.

Next, in the third step, a laser beam is irradiated on the aligned imaging film on the transparent substrate (ST3). Then, the color layer exposed to the laser beam is transferred to the transparent substrate by the LTHC layer. When the LTHC layer and the supporting layer are removed from the imaging film, the color filter is left on the transparent layer (ST4). By repeating the same process, the color filter of R, G, and B is formed on the substrate.

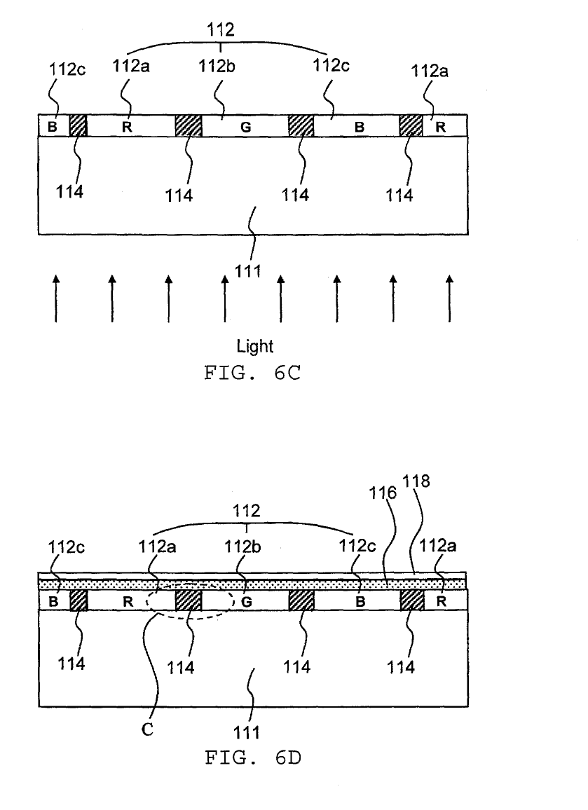

A method of fabricating a color filter panel will now be described with reference to FIGS. 6A to 6D.

In FIG. 6A, a color filter 112 is formed on a transparent substrate 111 by the same process shown in FIG. 5. The color filter 112 includes three sub-color filters 112a, 112b, and 112c of R, G, and B. Because the color filter 112 is formed by using an imaging film, the process of curing the color filter 112 may be omitted in the method according to the present invention.

In FIG. 6B, a black resin layer 113 is formed on the transparent substrate 111 including the color filter 112. The black resin layer 113 covers the color filter 112. The black resin layer 112 may be formed of either a liquid resin material or a solid resin material. The solid resin material is laminated and includes a laminating substrate and a black resin layer. The resin material includes carbon (C) and is negative-photosensitive.

In FIG. 6C, the black resin layer 113 (shown in FIG. 6B) is exposed to the light from the back side of the transparent substrate 111 and the unexposed black resin layer 113 is developed. Therefore, a black matrix 114 is formed to adjoin the color filter 112. According to the conventional art, the black matrix is formed by exposing the substrate from the front side by photolithography. In the present invention, the black matrix 114 is formed by exposing the substrate from the back side and using the color filter 112 as a mask. The black matrix 114 is then self-aligned. Therefore, a process of using a mask is not necessary.

In the mean time, the black matrix 114 has substantially the same height as the color filter 112, and an overcoat layer is not necessary to planarize the surface of the transparent substrate 111 including the color filter 112 and the black matrix 114. For example, a difference in height between the color filter 112 and the black matrix 114 is within ±0.2. Therefore, the number of fabricating processes and fabricating expenses are reduced.

In FIG. 6D, a common electrode 116 is formed on the color filter 112 and the black matrix 114 by depositing a transparent conductive material such as ITO. Next, an alignment layer 118 is formed on the common electrode 116 and is formed of a high molecule substance such as polyimide. The alignment layer 118 is aligned to control the alignment of the liquid crystal molecule by a rubbing method or a photo-aligning method.

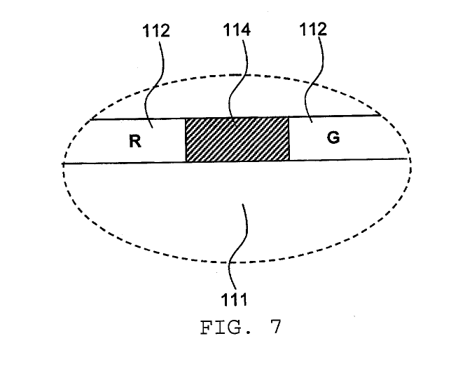

FIG. 7 is a view of showing the magnified region “C” of FIG. 6D. As shown in FIG. 7, a black matrix 114 has substantially the same height as the color filters 112. Therefore, the surface of the color filter panel black matrix 114 and the color filter 112 is flat, so that an overcoat layer is not necessary. Also, because a pattern of the color filter is formed by the thermal imaging method, a width of the black matrix 114 remains uniform.

When the color filter panel for an LCD device of extended graphic array (XGA) is fabricated according to the present invention, the black matrix is formed to have a width as small as 10. Thus, the light leakage is prevented.

It will be apparent to those skilled in the art that various modifications and variations can be made in the method of fabricating a color filter panel for a liquid crystal display device using thermal imaging of the present invention without departing from the spirit or scope of the inventions. Thus, it is intended that the present invention covers the modifications and variations of this invention provided they come within the scope of the appended claims and their equivalents.

What is claimed is:

1. A method of fabricating a color filter panel for a liquid crystal display device, comprising:
aligning a transcription film having a color layer, a light-to-heat conversion layer, and a supporting film on a color filter substrate;
selectively performing a thermal imaging process on the transcription film; and
removing the transcription film except for a portion where the thermal imaging process is performed, thereby forming a color filter on the color filter substrate.

2. The method of claim 1, wherein the selectively performing a thermal imaging process includes selectively irradiating a laser beam on the transcription film.

3. The method of claim 1, further comprising repeating the aligning a transcription film, selectively performing a thermal imaging process, and removing the transcription film until the color filter having three colors is formed on the color filter substrate.

4. The method of claim 1, wherein the transcription film has an adhesive layer on a side of the color layer facing into the color filter substrate.

5. A method of fabricating a color filter panel for a liquid crystal display device, comprising:
aligning a transcription film having a color layer, a light-to-heat conversion layer, and a supporting film, on a color filter substrate;
selectively performing a thermal imaging process on the transcription film;
removing the transcription film except for a portion where the thermal imaging process is performed, thereby forming a color filter on the color filter substrate; and
forming a black matrix between the color filters, the black matrix having a height substantially the same as the color filter.

6. The method of claim 5, wherein the black matrix and the color filter have a difference less than 0.2 μm in height.

7. The method of claim 5, wherein the forming a black matrix between the color filters includes:
depositing a black resin layer on the color filter substrate including the color filter;
exposing the black resin layer with light from a back side of the color filter substrate using the color filter as a mask; and
removing an unexposed portion of the black resin layer.

8. The method of claim 7, wherein the black resin layer is formed of one of a solid phase resin and a liquid phase resin.

9. The method of claim 7, wherein the black resin layer is formed of carbon.

10. The method of claim 7, wherein the black resin layer is negative-photosensitive.

11. The method of claim 7, further comprising forming a common electrode on the color filter and the black resin layer.

12. The method of claim 11, wherein the common electrode is formed of indium tin oxide.

13. A method of fabricating a liquid crystal display device, comprising:
aligning a transcription film having a color layer, a light-to-heat conversion layer, and a supporting film on a color filter substrate;
selectively performing a thermal imaging process on the transcription film;
removing the transcription film except for a portion where the thermal imaging process is performed, thereby forming a color filter on the color filter substrate;
forming a black matrix between the color filters, the black matrix having a height substantially the same as the color filter;
forming a thin film transistor on an array substrate; and
forming a pixel electrode on the array substrate, the pixel electrode being connected to the thin film transistor; and
forming a liquid crystal layer between the array substrate and the color filter substrate.

14. The method of claim 13, wherein the black matrix and the color filter have a difference less than 0.2 μm in height.

15. The method of claim 13, wherein the forming a black matrix between the color filters includes:
depositing a black resin layer on the color filter substrate including the color filter;
exposing the black resin layer with light from a back side of the color filter substrate using the color filter as a mask; and
removing an unexposed portion of the black resin layer.

16. The method of claim 15, wherein the black resin layer is formed of one of a solid phase resin and a liquid phase resin.

17. The method of claim 15, wherein the black resin layer is formed of carbon.

18. The method of claim 15, wherein the black resin layer is negative-photosensitive.

19. The method of claim 13, further comprising forming a common electrode on the color filter and the black matrix.

20. The method of claim 19, wherein the common electrode is formed of indium tin oxide.
